(19) United States
(12) Patent Application Publication
(10) Pub. No.: US 2007/0210478 A1
(43) Pub. Date: Sep. 13, 2007

(54) Method of manufacturing an end cap of a linear guideway

(75) Inventor: Po-Lin Pan, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/372,869

(22) Filed: Mar. 10, 2006

(51) Int. Cl. B29C 45/00

(52) U.S. Cl. 264/161; 264/328.1; 264/334; 264/235; 264/328.18

(57) ABSTRACT

A method of manufacturing an end cap of a linear guideway can keep the finished end cap from constant deformation during storage. The method is to arrange a rib on the intermediate product during the manufacturing process, the rib can be cut away from the intermediate product after stress relief, and thus preventing severe deformation of the intermediate product caused by stress relief.

### BACKGROUND OF THE INVENTION

1. Field of the Invention

The present invention relates to a method of manufacturing an end cap of a linear guideway, and more particularly to a manufacturing method capable of releasing the material's residual stress after injection molding and keeping the end cap from constant deformation during storage.

1. Description of the Prior Art

A linear guideway essentially comprises a rail and a slide block. The rail is an elongated work piece defined with rolling grooves for enabling the rolling elements to roll therealong, and the slide block is a reverse U-shaped work piece in which is also defined rolling grooves for mating with the rolling grooves of the rail, allowing the rolling elements to roll within the rolling passage defined by the rolling grooves of the slide block and the rail. For enabling the rolling elements to circulate in the linear guideway, the slide block must be provided at both ends thereof with two end caps that have a return path for enabling the rolling elements to roll endlessly in the rolling passage defined by the rolling grooves of the slide block and the rail.

FIG. 1 is a front view of a conventional end cap. Since the end cap 1 is to be mounted on the rail (not shown) of a linear guideway, it is reverse U-shaped so as to accommodate the square configuration of the rail. The reverse U-shaped end cap 1 includes a mid connecting portion 11 and two side arms 12. Each of the side arms 12 is defined with return paths 121 for enabling the rolling elements (not shown) to circulate in the rolling passage defined by the rolling grooves of the slide block and the rail.

All the existing end caps are of reverse U-shaped structures, and after injection molding, the fiber orientation (fiber's length direction), the heat stress and the molecule chain of the end caps are affected by the factors of flow rate, shearing and tensile residual stress and etc. Therefore, due to stress relief, the end cap 1 will shrink within a certain period of time after mold release and will shrink toward the rail, this will result in an interference of the inner surface of the end cap 1 with the rail, and will cause misalignment of the return paths 121 and other holes, adversely affecting the function of the linear guideway. The current solution to the abovementioned problem is to push the end cap in a direction reverse to the shrinking direction by using a tool, creating a plastic deformation. However, the plastic deformation is difficult to control because of its elastic recoil property, and this will increase the cost of mass production. If the deformation is compensated during the course of mold opening, the amount of compensation is difficult to control because the plastic deformation has to do with many factors: including time for mold opening, temperature, material and injection pressure, it will vary with each production.

The present invention has arisen to mitigate and/or obviate the afore-described disadvantages.

### SUMMARY OF THE INVENTION

The primary objective of the present invention is to provide a method of manufacturing an end cap of a linear guideway, which can prevent the end cap from constant deformation during storage.

A method of manufacturing an end cap of a linear guideway in accordance with the present invention comprises the steps of:

preparing a mold having a configuration of the reverse U-shaped end cap, the configuration of the intermediate product including a configuration of a rib connected between the two side arms;

injecting material into the mold;

mold releasing;

waiting for a period of time;

cutting away the rib.

According to the method of the present invention, the rib connected between the two side arms of the end cap (intermediate product) is cut away after a certain period of time after mold releasing, and thus the residual stress of the material can be released during this period of waiting time. And cutting away the rib connected the two side arms of the end cap after the elimination of the material's stress (or most of the stress is eliminated) can prevent the occurrence of a great deformation of the end cap caused by the change of the residual stress.

The residual stress of the material will change with time. When the residual stress is great and the temperature is high, the residual stress will be released quickly. And contrarily, when the residual stress is small and the temperature is low, the residual stress will be released slowly. Therefore, the stress at the instant of releasing mold changes the fastest since the temperature is the highest at that moment. After that, with gradual reduction in residual stress, the stress relief will also slow down gradually.

In order to speed up the stress relief, it can heat the end cap (the intermediate product with the rib) during the waiting period, accelerating the stabilization of the material. The method of heating is to put the intermediate product into hot water, in addition to releasing stress, the intermediate product will also absorb moisture, thus preventing the end cap from deformation after absorbing moisture during use.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a front view of a conventional end cap;

FIG. 2 is a front view of an intermediate product resulting from a method of manufacturing an end cap of a linear guideway in accordance with the present invention;

FIG. 3 is a stereographic of FIG. 2; and

FIG. 4 is an illustrative view of an intermediate product resulting from a method of manufacturing an end cap of a linear guideway in accordance with another embodiment of the present invention.

### DETAILED DESCRIPTION OF THE PREFERRED EMBODIMENTS

The foregoing, and additional objects, features and advantages of the present invention will become apparent from the following detailed description of preferred embodiments thereof, taken in conjunction with the accompanying drawings.

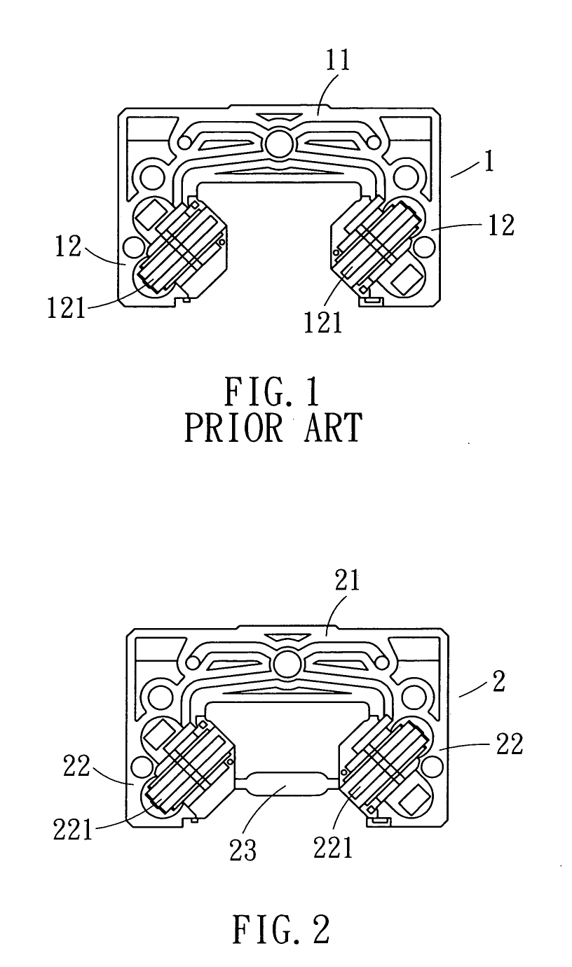

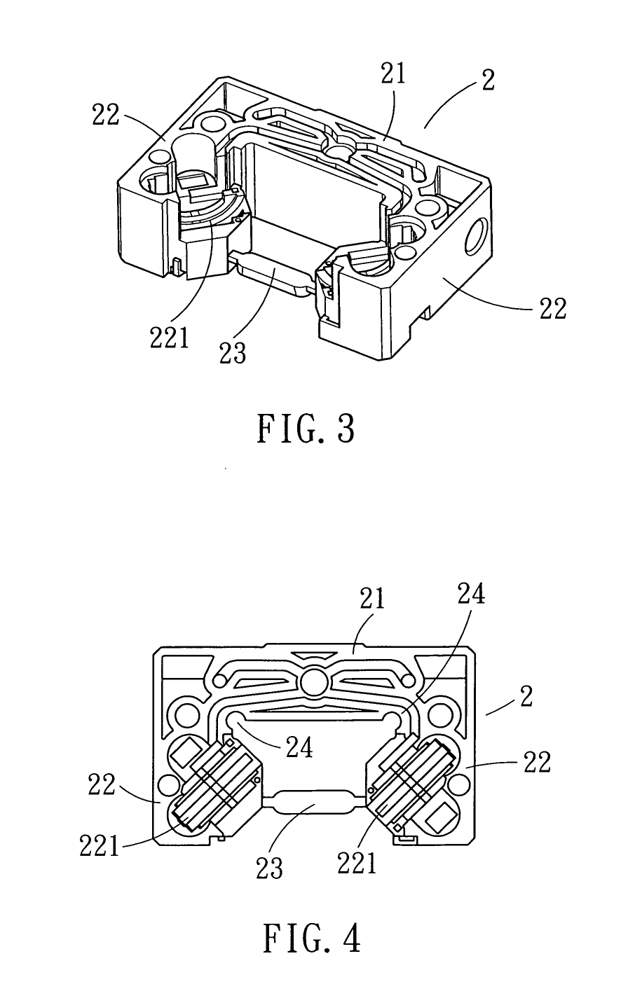

FIG. 2 is a front view of an intermediate product resulting from a method of manufacturing an end cap of a linear guideway in accordance with the present invention. FIG. 3 is a stereographic of FIG. 2. The finally resultant end cap (the final product) of the present invention is identical with the conventional end cap in outline, and the structure of the intermediate product of the present invention is shown in FIG. 2. The intermediate product shown in FIG. 2 comprises a connecting portion 21 and two side arms 22 at both sides of the connecting portion 21. Each of the side arms 22 is defined with a return path 221. For preventing the occurrence of deformation during the course of mold release, a rib 23 is arranged between the two side arms 22 for connecting them together, thus preventing severe deformation of the intermediate product 2 caused by stress relief. After a certain period time after mold release, the rib 23 can be cut away from the intermediate product 2, thus obtaining a finished end cap. The method of manufacturing the end cap comprises in the steps of:

1, preparing a mold having a configuration of the intermediate product 2, the configuration of the intermediate product 2 comprises the configuration of a reverse U-shaped end cap that includes the configuration of the mid connecting portion 21, the configuration of the two side arms 22 at both sides of the connecting portion 21, and the configuration of the rib 23 for connecting the two side arms 22;

2, injecting material into the mold, filling the configuration of the intermediate product with material, as shown in FIG. 2;

3, taking out the resultant intermediate product 2 after solidification of the material;

4, waiting for a period of time;

5, obtaining a finished end cap of a linear guideway by cutting away the rib 23 from the intermediate product 2.

The entrance of the mold for injection of material is called pouring gate, and it will adversely affect the appearance of the end cap if there are too many pouring gates in the surface of the end cap. Therefore, the pouring gates 23 can be arranged in the rib 23. After cutting away the rib 23, the pouring gates 23 will disappear.

The end cap is normally made of plastic material, and the plastic material can be mixed with glass fiber so as to improve the impact strength and the abrasion resistance of the end cap.

However, the greater the hardness of the plastic, the more resistance it has to deformation, and it will take more time to balance them. If the material has been cooled, the release of the tensile residual stress of the material molecule chain and the fiber flow will become difficult. In order to speed up the stress relief, it can heat (tempering) the intermediate product 2 during the waiting period, thus accelerating the stabilization of the material. The method of heating is to put the intermediate product 2 into hot water, in addition to releasing stress, the intermediate product 2 will also absorb moisture, preventing the end cap from deformation after absorbing moisture during use. The essential role of the heating process is to keep the molecules and fibers flowing slowly within the finished product, achieving the purpose of stress releasing. Heating with hot water of 50-80 centigrade degrees not only can achieve the abovementioned affects, but also can speed up the moisture absorbing process (the material will be slightly inflated after absorbing moisture).

FIG. 4 is an illustrative view of an intermediate product resulting from a method of manufacturing an end cap of a linear guideway in accordance with another embodiment of the present invention, wherein a heat-escaping groove 24 is formed in each of the corners between the connecting portion 21 and the side arms 22, and the heat-escaping groove 24 is a circular groove. Since the intermediate product 2 is a reverse U-shaped structure, the comers between the connecting portion 21 and the side arms 22 are nearly right angles, as a result, heat stresses will be focused in these two corners. The higher the temperature, the greater the deformation, therefore, it will lead to a relatively great deformation of the end cap. The heat-escaping grooves 24 can enable the heat to be transmitted and distributed evenly, in this way, the problem of the heat stress concentration in the corner is solved.

While we have shown and described various embodiments in accordance with the present invention, it should be clear to those skilled in the art that further embodiments may be made without departing from the scope of the present invention.

What is claimed is:

1. A method of manufacturing an end cap of a linear guideway, the end cap being reverse U-shaped and comprising a mid connecting portion and two side arms at both sides of the mid connecting portion, the end cap being mounted on a rail of linear guideway for enabling rolling elements to circulate, the method of manufacturing the end cap comprising the steps of:
preparing a mold having a configuration of the reverse U-shaped end cap, the configuration of the intermediate product including a configuration of a rib connected between the two side arms;
injecting material into the mold;
mold releasing;
waiting for a period of time;
cutting away the rib.

2. The method of manufacturing an end cap of a linear guideway as claimed in claim 1, wherein an intermediate product resulting from the step of molding releasing is heated during the waiting period, so as to accelerate stabilization of the intermediate product.

3. The method of manufacturing an end cap of a linear guideway as claimed in claim 2, wherein a method of heating is to put the intermediate product into hot water, so that, in addition to releasing stress, the intermediate product will absorb moisture, preventing the end cap from deformation after absorbing moisture during use.

4. The method of manufacturing an end cap of a linear guideway as claimed in claim 2, wherein the intermediate product is heated to 50-80 centigrade degrees.

5. The method of manufacturing an end cap of a linear guideway as claimed in claim 3, wherein the intermediate product is heated to 50-80 centigrade degrees.

6. The method of manufacturing an end cap of a linear guideway as claimed in claim 1, wherein pouring gates of the mold are designed to be located in the rib.

7. The method of manufacturing an end cap of a linear guideway as claimed in claim 1, wherein a heat-escaping groove is formed in each comers between the connecting portion and the side arms.

8. The method of manufacturing an end cap of a linear guideway as claimed in claim 7, wherein the heat-escaping groove is a circular groove.

9. The method of manufacturing an end cap of a linear guideway as claimed in claim 1, wherein the material is plastic.

10. The method of manufacturing an end cap of a linear guideway as claimed in claim 9, wherein the plastic is mixed with glass fiber for improving the strength of the plastic.
